(19) United States
(12) Patent Application Publication
(10) Pub. No.: US 2024/0150156 A1
(43) Pub. Date: May 9, 2024

(54) LIFTING DEVICE

(71) Applicant: GL GmbH Metall- und Werkstatttechnik, Frickenhausen (DE)

(72) Inventors: Marcel Franz, Nuertingen (DE); Holger Henzler, Nuertingen (DE)

(21) Appl. No.: 18/387,974

(22) Filed: Nov. 8, 2023

(30) Foreign Application Priority Data
Nov. 8, 2022 (DE) 10 2022 129 425.0

(51) Int. Cl. B66F 5/04

(52) U.S. Cl. CPC B66F 5/04; B66F 2700/025; B66F 2700/057

(57) ABSTRACT

A mobile lifting device, which preferably has a mobile frame with a plurality of castors. The lifting device has a closed fluid circuit, in particular a hydraulic circuit. It has a cylinder with an elevating work chamber. The elevating work chamber is fluidically connected to a fluid reservoir via a first fluid conduit and a second fluid conduit. In the first fluid conduit, a main pump is arranged which can be driven by means of a rotatably drivable hand tool to supply fluid from the fluid reservoir into the elevating work chamber, thereby extending a piston rod of the fluid cylinder, for example, to lift a load. In the second fluid conduit, a flow control arrangement is arranged which can be switched between a blocking state and a release state by means of a lowering operating element. When the piston rod is extended, the flow control arrangement is in the blocking state. To retract the piston rod, it is switched to the release state, allowing fluid to flow out of the elevating work chamber through the second fluid conduit.

### CROSS REFERENCE TO RELATED APPLICATIONS

This application claims priority under 35 U.S.C. § 119 to the following German Patent Application No. 10 2022 129 425.0, filed on Nov. 8, 2022, the entire contents of which are incorporated herein by reference thereto.

### TECHNICAL FIELD

The present disclosure relates to a lifting device, in particular a mobile and preferably a mobile or rollable lifting device. The lifting device is configured to lift a load with fluidic support relative to the ground on which the lifting device stands and to hold it there.

### BACKGROUND

Such lifting devices can be used, for example, in the automotive industry to lift heavy loads during the assembly of a vehicle, to position them at a suitable location in the vehicle body and to fasten them there. For this purpose, known lifting devices have, for example, a foot pedal by means of which a foot pump can be actuated so that hydraulic fluid is pumped into a hydraulic cylinder in order to raise it step by step with the load. However, lifting a load over longer distances is relatively strenuous because such lifting devices cover a distance of about 1 cm per foot pedal movement under load.

Lifting devices are also known which have a compressed air cylinder for pressure support, which is connected to a stationary compressed air source via a compressed air line. However, the support is small and is used in particular for rapid compressed air-assisted movement of a piston of the compressed air cylinder when no load needs to be lifted (load-free movement). The disadvantage of such lifting devices is the required fluid line connection to a compressed air connection in the environment, for example in a building. In a factory, workshop or assembly hall, such fluid conduits lying on the floor constitute an obstacle and also a safety hazard.

### BRIEF SUMMARY

Based on such lifting devices known from practice, it can be regarded as the object of the present disclosure to create a lifting device, in particular a mobile lifting device, which can also cover long stroke distances in a simple manner and, moreover, does not require a fluid conduit connection to an external pressure source.

This object is solved by a lifting device including: a fluid cylinder comprising a cylinder housing, an elevating work chamber in the cylinder housing, a piston and a piston rod, which is fixed with an inner end to the piston and which projects with an outer end from the cylinder housing and has there a support part for supporting a load, wherein the piston adjoins the elevating work chamber and wherein the piston and the piston rod are mounted movably in a lifting direction, a fluid reservoir, a first fluid conduit and a second fluid conduit, each fluidically connecting the fluid reservoir and the elevating work chamber, a rotatably drivable main pump in the first fluid conduit, which is configured to supply fluid from the fluid reservoir via the first fluid conduit into the elevating work chamber in a driven state, a tool interface drivingly connected to the main pump and configured to be connected to a rotatably drivable hand tool to drive the main pump, a flow control arrangement in the second fluid conduit, which in a blocking state blocks fluid flow from the elevating work chamber via the second fluid conduit into the fluid reservoir and in a release state allows fluid flow from the elevating work chamber via the second fluid conduit into the fluid reservoir, and a lowering operating element connected to the flow control arrangement and configured to switch the flow control arrangement between the blocking state and the release state.

The lifting device according to the present disclosure has a fluid cylinder. The fluid cylinder has a cylinder housing that surrounds an elevating work chamber. A piston is arranged adjacent to the elevating work chamber so as to be movable in a lifting direction. A piston rod is attached to the piston at its inner end. The outer end of the piston rod opposite to the inner end protrudes from the cylinder housing and serves there as a support part or has a support part there. The support part is configured to support or arrange a load. By changing a fluid volume in the elevating work chamber, the piston can be moved in the lifting direction in order to extend or retract the piston rod. For this purpose, the elevating work chamber is part of a fluid circuit, in particular a closed fluid circuit. The fluid is preferably a liquid, for example a hydraulic oil.

The fluid circuit of the lifting device also has a fluid supply or fluid reservoir. A first fluid conduit and a second fluid conduit each fluidically connect the fluid reservoir and the elevating work chamber. The first fluid conduit and the second fluid conduit are fluidically connected in parallel.

The lifting device also has a rotatably drivable pump which is referred to as the main pump to distinguish it from optionally available further pumps. The main pump is arranged in the first fluid conduit. In the driven state, the main pump can supply fluid through the first fluid conduit, in particular from the fluid reservoir via the first fluid conduit into the elevating work chamber, in order to extend the piston rod.

The lifting device according to the present disclosure is designed without a motor. For driving the main pump, a tool interface is provided which is drive-connected to the main pump. The tool interface is configured to be connected to a rotatably drivable hand tool, so that the main pump can be driven by means of the hand tool. The hand tool has a motor, preferably an electric motor, for this purpose. The hand tool has an internal energy storage device (e.g. rechargeable battery) as an energy source for operating its motor, and can therefore be operated without an electrical line connection to the supply network. The hand tool can be, for example, a (cordless) drill or a cordless screwdriver.

The lifting device according to the present disclosure also has a flow control arrangement in the second fluid conduit. The flow control arrangement can be switched between a blocking state and a release state. The switching is performed by means of a lowering operating element connected to the flow control arrangement. In the blocking state, a fluid flow from the elevating work chamber via the second fluid conduit into the fluid reservoir is blocked. In the release state, fluid flow from the elevating work chamber via the second fluid conduit into the fluid reservoir is enabled. The flow control arrangement is preferably configured to throttle the fluid flow flowing through the second fluid conduit in the release state and/or to control or regulate it as a function of volume flow and/or mass flow.

The lifting device can be very easily implemented as a mobile lifting device. Fluid lines to external pressure sources or external fluid circuits (for example in a building) are not required. The lifting device also does not require its own motor. Longer stroke distances can be covered without the need for power or considerable effort by driving the main pump with a hand tool. This means that even stroke distances of 100 cm and more can be covered very fast. The extension speed under load, for example, can be at least 10 cm to 15 cm/s if the main pump is operated at its rated speed for a fast stroke in the extension direction of the piston rod.

The lifting device thus operates gently and facilitates handling for the operator. Safety-critical fluid conduits to external pressure sources can be omitted. The lifting device also requires no electrical power supply. It can be designed completely without line and cable connections.

The main pump is preferably a gear pump. Gear pumps are robust and quiet, so that no loud noises are generated when a load is lifted during work use, so that labor regulations can also be complied with without any problems.

The fluid cylinder can thus be a telescopic cylinder. The piston and the piston rod of the lifting device can consist of several parts mounted telescopically on each other. With the piston rod fully retracted, thus a desired working height and a large stroke distance of, for example, 100 cm and more and, in an embodiment example, about 120 cm can be achieved at the same time.

The lifting device is preferably designed as a mobile unit in such a way that it can be moved by a single person and positioned at a desired location on a ground. For this purpose, the lifting device can have a frame, a tripod or the like. In particular, it is preferred if the lifting device has a mobile frame with a plurality of castors, for example a mobile frame with at least 3 to 5 arms and one castor each, similar to an office chair. In particular, the lifting device designed as a mobile unit does not have its own travel drive, but can be moved over a ground by an operator by pushing or pulling.

In a preferred embodiment, the lifting device has a locking means that can be switched between a locking state and a release state. In the locking state, relative rotation of the support part about a longitudinal axis of the piston rod relative to the mobile frame is blocked. This locking state is advantageous when the piston rod is fully retracted or in the vicinity of its fully retracted position. Then, by means of the support part, the lifting device can be moved or aligned. In doing so, the mobile frame also moves relative to the ground. If, on the other hand, the support part were rotatable about the longitudinal axis of the piston rod, no rotational movement of the mobile frame relative to the ground could be caused by rotating the support part.

In the release state, such relative rotation of the support part about the longitudinal axis of the piston rod relative to the mobile frame is possible. This is particularly useful when the piston rod is extended, for example fully extended. Then, the support part (with or without load) can be positioned with respect to its rotational position about the longitudinal axis of the piston rod without this having any effect on the mobile frame.

It may be advantageous to design the locking means to automatically assume the locking state or to be brought into the locking state only when the piston rod is fully retracted or is in the vicinity of the fully retracted position. Additionally or alternatively, the locking means may be configured to automatically assume the release state or to be brought into the release state only when the piston rod is a minimum distance away from its fully retracted position. In this way, for example, the locking state can be prevented from being assumed when the piston rod lifts a load. This is because it is usually undesirable in this position for the lifting device to rotate relative to the ground when the rotational position of the support part about the longitudinal axis of the piston rod is changed.

It is also preferred if one or more of the castors present on the mobile frame can be secured against rolling movement by means of a brake. The brake can, for example, be switched between a braking position and a release position releasing the castor by foot actuation by an operator.

In particular, the fluid circuit of the lifting device is closed and has no fluid connection to an external pressure source or other external fluid circuits, such as a pressure source or pressure connection in or on a building. All fluid connections required for the use and operation of the lifting device run exclusively within the lifting device and, in particular, are part of the mobile or movable lifting device.

In one embodiment, the lifting device may have a fluid container arranged outside the cylinder housing. The fluid container then has the fluid reservoir. In a preferred embodiment, the fluid container surrounds the cylinder housing (e.g., coaxially and/or completely in the circumferential direction) so that the fluid reservoir is an intermediate space between the fluid container and the cylinder housing. In this embodiment, the fluid reservoir may be an annular space around the cylinder housing.

It is advantageous if the cylinder is a single-acting cylinder which can be extended by means of the main pump by filling the elevating work chamber. In this embodiment, the retraction movement is effected by the weight force acting on the piston rod, for example the support part and/or a load.

As an alternative to a single-acting cylinder, a double-acting cylinder can also be provided. The double-acting cylinder has a lowering work chamber in addition to the elevating work chamber. The piston fluidically separates the two work chambers. In this embodiment, a retracting movement of the piston rod can be actively supported by pressurizing the lowering work chamber. Preferably, the lowering work chamber forms the fluid reservoir at least partially or completely. A fluid container separate from the cylinder housing can be omitted in this embodiment, but may optionally be present.

If the cylinder is a double-acting cylinder, fluid can be supplied by means of the main pump in two directions through the first fluid conduit, i.e. from the lowering work chamber to the elevating work chamber and vice versa from the elevating work chamber to the lowering work chamber, depending on the direction of rotation of the main pump.

It is advantageous if a third fluid conduit is also provided, which is fluidically connected in parallel with the first fluid conduit and the second fluid conduit. An auxiliary pump can be present in the third fluid conduit. In particular, the auxiliary pump is a pump operated by muscle power, especially a foot pump. A pump operating element is provided for operation, which may be designed as a foot pedal, for example. By actuating the auxiliary pump by means of the pump operating element, fluid can be supplied through the third fluid conduit from the fluid reservoir into the elevating work chamber. For example, the auxiliary pump is used to perform a finer, more precise adjustment of the desired stroke position, while the main pump is mainly used to perform a rapid stroke movement. For example, the auxiliary pump can be configured to cause the piston rod or support part to travel a maximum distance of 5 cm or 3 cm or 2 cm or 1 cm in the lifting direction for each complete pumping movement of the pump operating element of the auxiliary pump when the support part is loaded with nominal load or maximum load.

It is preferred if the lowering operating element and/or the pump operating element is a foot pedal arranged for actuation with a foot. Such a foot pedal is arranged in the area of the vertically lower end of the fluid cylinder so that it can be reached with the foot of an operator standing next to it and is preferably arranged at a distance from the ground when actuated with the foot in any actuation position.

The flow control arrangement is preferably set up in such a way that when the lowering operating element is actuated to lower a load or the support part without a load, a predetermined lowering speed is reached or the lowering speed is at least within a predetermined speed range. In one embodiment, a lowering speed of 10 cm/s to 20 cm/s can be predefined or set, for example 15 cm/s, if the support part is loaded with a nominal load or a maximum load.

The nominal load of the support part is the load which the lifting device is configured for. At nominal load, the lifting device preferably operates in an ideal operating state which the components of the lifting device are configured and/or set up for. The maximum load is the maximum load that may be placed on the support part.

In one embodiment, the flow control arrangement may include a valve that is switchable to switch the flow control arrangement between the blocking state and the release state. The switchable valve may be, for example, a pilot-operated check valve or a directional control valve (in particular, a 2/2-directional control valve). The switchable valve can be blocking in the initial state (blocking state of the flow control arrangement), for example mechanically biased into the initial state. By means of the lowering operating element, the switchable valve can be opened to allow a defined fluid flow (release state of the flow control arrangement).

In an advantageous embodiment, the flow control arrangement is configured to set the fluid flow in the release state to a target flow value or a target flow range, in particular to regulate it automatically. For example, the flow control arrangement can have a pressure compensator for this purpose, which is also referred to as a differential pressure valve.

### BRIEF DESCRIPTION OF THE DRAWINGS

Advantageous embodiments of the present disclosure result from the dependent patent claims, the description and the drawing. In the following, advantageous embodiments are explained in detail with reference to the drawings. Shown in the drawing:

FIG. 1 is a perspective view of an embodiment of a mobile lifting device according to the present disclosure,

FIG. 2 shows the lifting device from FIG. 1 with the housing cover partially removed,

FIG. 3 shows a block diagram-like principle representation of an exemplary embodiment of a lifting device according to the present disclosure with a single-acting cylinder,

FIG. 4 shows a block diagram-like principle representation of a lifting device according to the present disclosure with a double-acting cylinder,

FIGS. 5 to 7, respectively, show a circuit diagram for a fluid circuit for any embodiment of the lifting device with a single-acting or double-acting cylinder, and

FIG. 8 is a schematic principle diagram of a telescopic cylinder that can be used in any embodiment of the lifting device.

### DETAILED DESCRIPTION

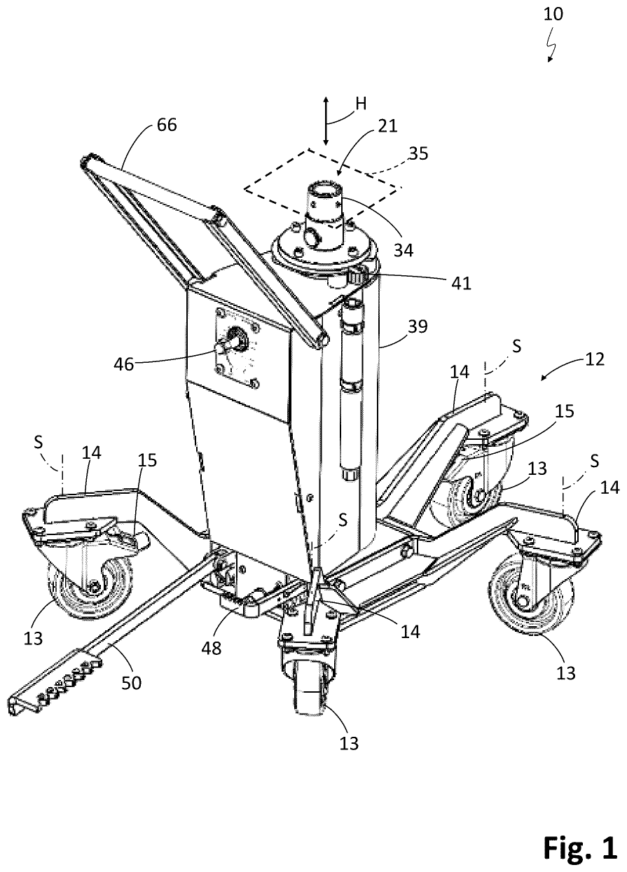

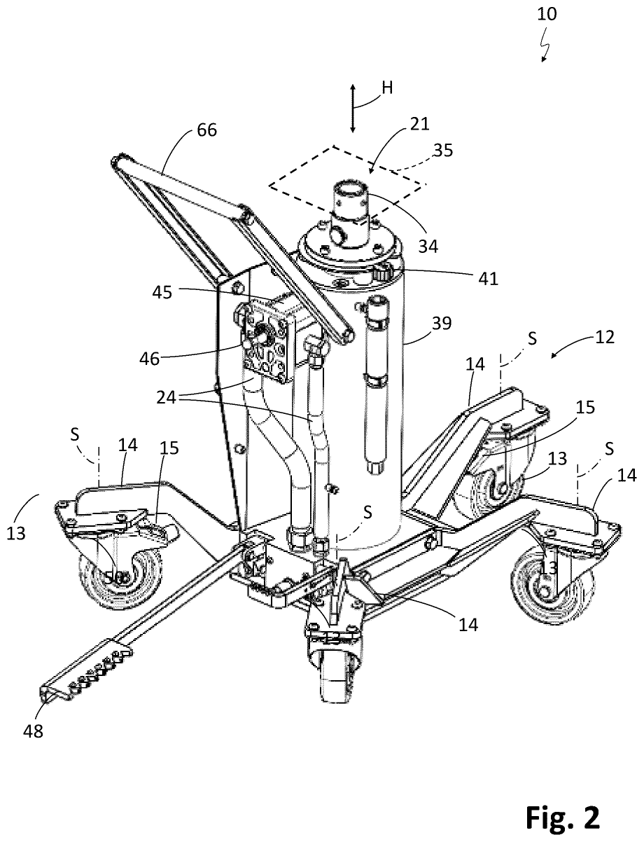

FIGS. 1 and 2 illustrate an embodiment of a lifting device 10. The lifting device 10 is designed as a mobile unit 11 for moving on a ground (in particular a floor). For this purpose, the lifting device 10 has a mobile frame 12 with a plurality of castors 13, wherein in particular at least three castors 13 and exemplarily five castors 13 are present. In FIGS. 1 and 2, each castor 13 is arranged on an arm 14 of the mobile frame 12, wherein a total of five arms 14 are present, each having a castor 13. One of the arms 14 is not visible in the perspective view of FIGS. 1 and 2.

One or more of the castors 13 may be pivotally mounted about a pivot axis S, the pivot axes S extending parallel to one another, in particular in a lifting direction H of the lifting device. The lifting direction H is oriented substantially vertically when the lifting device 10 is in a ready-to-use state and, for example, the mobile frame 12 is set up on a ground.

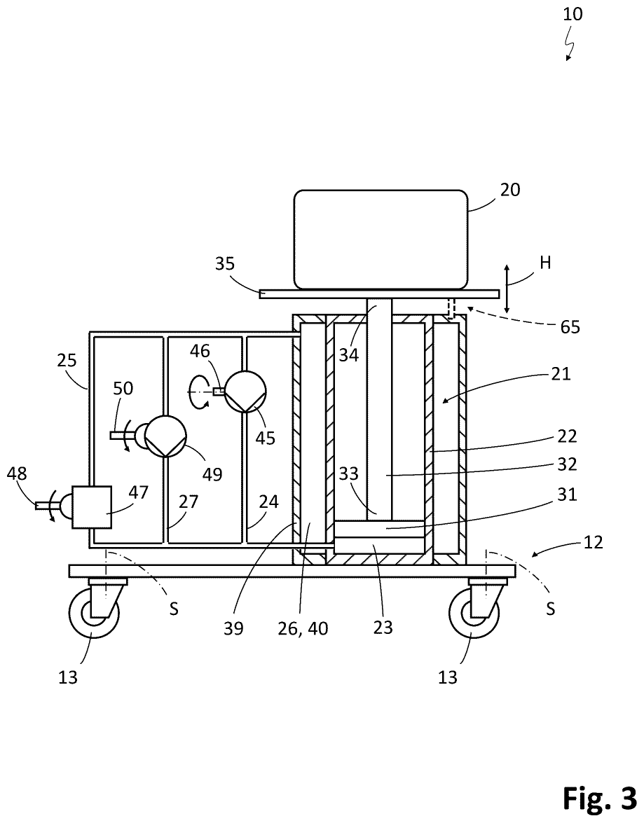

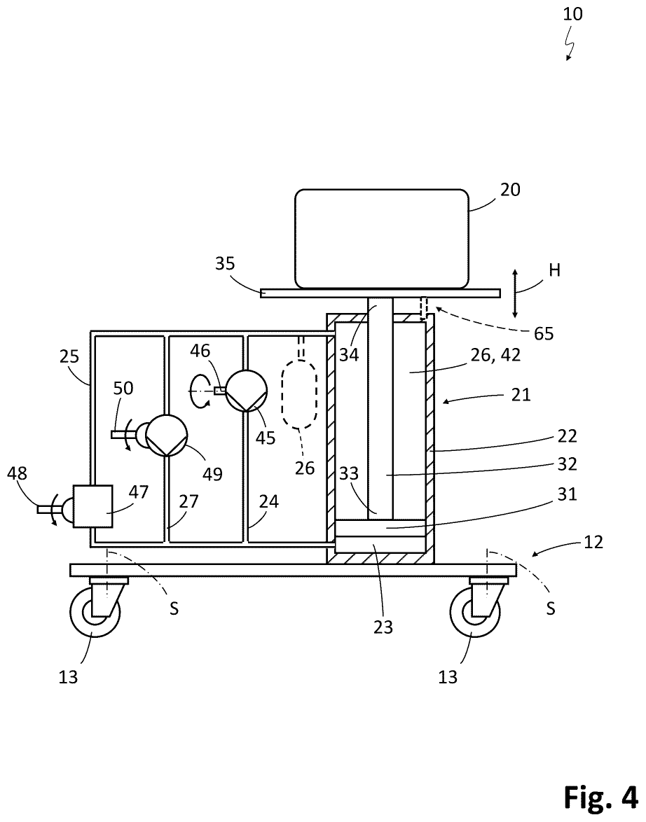

The mobile frame 12 may be similar in design to the frame of a swivel chair or office chair (FIGS. 1 and 2). Alternatively, the mobile frame 12 may have a different arrangement of castors 13, for example, three or four castors supporting a plate or other base body of the mobile frame 12, similar to shopping carts or floor-borne vehicles movable by muscle power (FIGS. 3 and 4).

By means of the mobile frame 12, the lifting device 10 can be moved relative to a ground to the desired place of action and may be positioned there. Preferably, at least one of the available castors 13 is associated with a brake 15 that secures the associated castor 13 in a braking state against turning or rolling on the ground. The brake 15 can, for example, be operable by the foot of an operator to switch it to the braking state and to the release state.

As an alternative to the illustrated embodiment example according to FIGS. 1 to 4, the castors 13 on the mobile frame 12 could also be movable between a support position and a retracted position. In the support position, they support the lifting device on the ground so that it can roll, while in the retracted position they allow frictional contact of mobile frame parts of the mobile frame on the ground so that rolling movement is no longer possible due to the friction that occurs between mobile frame parts and the ground.

In particular, the lifting device 10 according to the present disclosure is configured to lift a load 20 in the lifting direction H. The lifting device may, for example, be a transmission lifter used in the automotive industry for lifting a transmission vertically upward into a vehicle body in order to connect the transmission in the vehicle body to other vehicle parts. The lifting device could also be set up in the manner of a lifting table for other loads 20.

In all embodiments, the lifting device 10 has a closed fluid circuit. Examples of embodiments of the fluid circuit are shown in FIGS. 3 to 7.

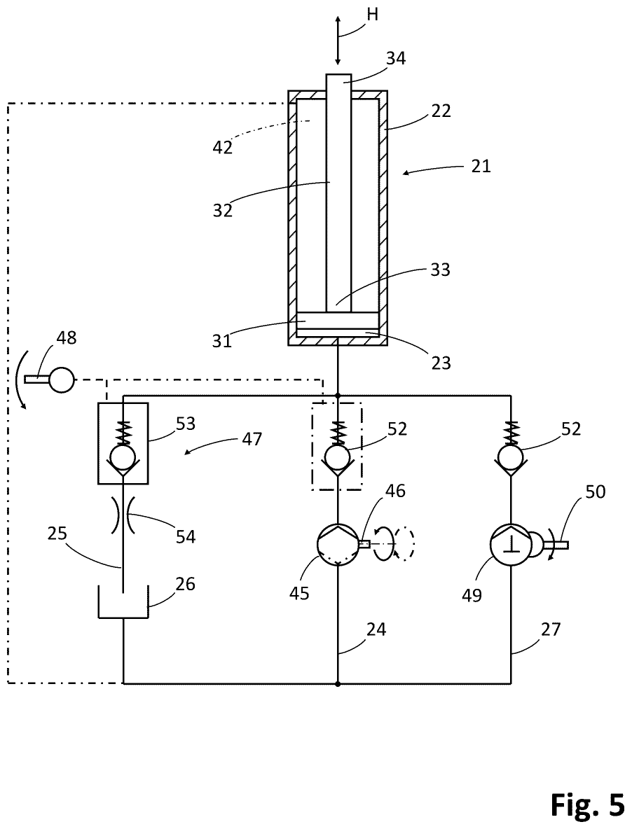

The lifting device 10 has a fluid cylinder 21 (cf. FIGS. 3 to 7). The fluid cylinder 21 can be a single-acting cylinder (FIGS. 3, 5 6 and 7) or a double-acting cylinder (schematically dash-dotted variation shown in FIGS. 4 to 7). It has a cylinder housing 22 in which there is an elevating work chamber 23. The elevating work chamber 23 is fluidically connected to a fluid reservoir 26 by means of a first fluid conduit 24 and by means of a second fluid conduit 25 fluidically connected in parallel thereto. In the preferred embodiment examples illustrated here, a third fluid conduit 27 is also present, which is fluidically connected in parallel with the first fluid conduit 24 and the second fluid conduit 25 and thus also establishes a fluid connection between the elevating work chamber 23 and the fluid reservoir 26.

It should be noted at this point that the fluid conduits 24, 25, 27 establish a fluid connection, but do not have to permanently allow fluid flow through the fluid conduit in question. This depends on the state of the components arranged in the respective fluid conduit 24, 25, 27.

The elevating work chamber 23 in the cylinder housing 22 is fluidically sealed on one side in the lifting direction H by a piston 31 mounted movably in the lifting direction H in the cylinder housing 22. A piston rod 32 is attached to the piston 31 with an inner end 33. The piston rod 32 extends from the inner end 33 in the lifting direction H to an opposite outer end 34. At the outer end 34, the piston rod 32 forms a support part 35 or is connected to a support part 35. Only by way of example, FIGS. 3 and 4 show a plate-shaped or table-plate-shaped support part 35 on which the load 20 can be arranged. The type and design of the support part 35 varies depending on the application, which type of loads 20 are to be lifted. The support part 35 is used to arrange the load on the lifting device 10 and is designed according to the load 20 to be lifted. It is also possible to provide several interchangeable support parts 35 of different design in the manner of a modular system, which can optionally be detachably attached to the outer end 34 of the piston rod 32 via a defined attachment interface.

The outer end 34 of the piston rod 32 is outside the cylinder housing 22 in any position of the piston 31.

In some embodiments, the fluid cylinder 21 is a single-acting cylinder. In this embodiment, the area present within the cylinder housing 22 that surrounds the piston rod 32 and is fluidically separated from the elevating work chamber 23 by means of the piston 31 need not be fluidically sealed from the environment of the lifting device 10. In this embodiment, the fluid reservoir 26 is arranged outside the cylinder housing 22, for example in a separate fluid container 39. In order to achieve a compact design of the lifting device 10, the fluid container 39 is arranged around the cylinder housing 22 in the embodiment examples according to FIGS. 1 to 3 and can completely enclose the latter in the circumferential direction about the lifting direction H. An intermediate space 40 between the cylinder housing 22 and the fluid container 39 forms the fluid reservoir 26 in this embodiment example. The intermediate space 40 or the fluid reservoir 26 may be an annular space that coaxially surrounds a longitudinal axis of the piston rod 32. The annular space may have a hollow cylindrical shape. However, it is also possible to align the fluid container 39 and the cylinder housing 22 non-coaxially.

As can be seen in FIGS. 1 and 2, a fluid port 41 (e.g., filler neck) may be provided on the fluid container 39, for example, on a lid or in a side wall of the fluid container 39, for filling and/or refilling a fluid.

In particular, it can be seen from FIG. 4 that the cylinder 21 can also be designed as a double-acting cylinder. In these embodiment examples, it has a lowering chamber 42 in addition to the lifting chamber 23. The piston 31 fluidically separates the elevating work chamber 23 from the lowering work chamber 42 in the cylinder housing 22. In this embodiment, at least part of the fluid reservoir or the entire fluid reservoir 26 is formed by the lowering work chamber 42. A fluid reservoir separate from the fluid cylinder 21 may be omitted in this embodiment, but may optionally be present, as shown dashed in FIG. 4.

Since the lowering work chamber 42 constitutes at least part or all of the fluid reservoir 26, the fluid conduits 24, 25, 27 in the double-acting cylinder shown in FIG. 4 fluidically connect the lowering work chamber 42 to the elevating work chamber 23.

In all embodiments, a rotatably drivable main pump 45 is disposed in the first fluid conduit 24. The main pump 45 is configured to cause fluid to flow through the first fluid conduit 24 in the driven state, at least in a direction from the fluid reservoir 26 to the elevating work chamber 23. As a result, fluid can be supplied into the elevating work chamber 23 and the piston 31 can be moved in the lifting direction H to extend the piston rod 32. In the process, a load 20 can be lifted. In the case of a double-acting cylinder 21, the main pump 45 can also be rotatably driven in the opposite direction to supply a fluid from the elevating work chamber 23 to the lowering work chamber 42. In this case, a retracting movement of the piston rod 32 can be supported.

The lifting device 10 does not have its own motor. To drive the main pump 45, the latter has a tool interface 46 that is configured to connect a rotatably drivable hand tool, for example, a cordless drill or a cordless screwdriver, to the main pump 45. The tool interface 46 can, for example, be designed as an external hexagon. In general, however, any known polygonal and/or multi-surface standardized tool interface may be used, for example, a slotted connection, a cross-slotted connection, an internal hexagon, an external or internal square, a six-arc tooth or “TORX” connection, etc. The tool interface 46 is arranged to be externally accessible to connect the hand tool to the tool interface 46.

A flow control arrangement 47 is disposed in the second fluid conduit 25, which can be switched from a blocking state and to a release state by means of a lowering operating element 48. In the blocking state, fluid can flow from the elevating work chamber 23 via the second fluid conduit 25 into the fluid reservoir 26, while the flow control arrangement 47 prevents such fluid flow in the blocking state.

In the optionally provided third fluid conduit 27, an auxiliary pump 49 is arranged, for example, which can be operated, for example, by muscle power via a pump operating element 50. When the pump operating element 50 is operated with muscle power, the auxiliary pump 49 causes a fluid flow from the fluid reservoir 26 through the third fluid conduit 27 into the elevating work chamber 23. By means of the optionally present auxiliary pump 49, for example, a finer, more precise positioning of the support part 35 or the load 20 in the lifting direction H can be achieved.

In the embodiment example illustrated here, both the lowering operating element 48 and the pump operating element 50 are designed as foot pedals, as can be seen in particular in FIGS. 1 and 2. For this purpose, the foot pedals are arranged at the bottom area of the mobile frame 12, so that they can be easily reached with the foot when the operator is standing on the ground next to the lifting device 10.

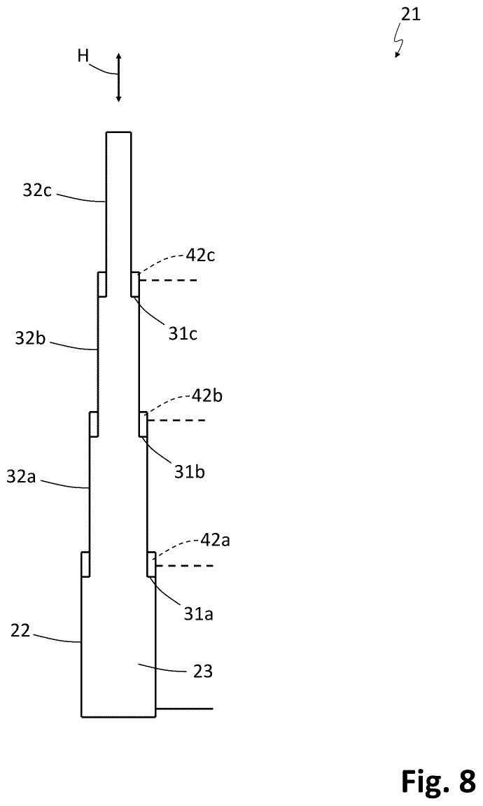

FIGS. 3 and 4 illustrate the fluid cylinder 21 with an integral rod-shaped piston rod 32. FIG. 8 schematically illustrates, in the manner of a block diagram, a telescopic cylinder 51 as may be used in any of the embodiments of the lifting device 10. The telescopic cylinder 51 has a telescopic piston rod 32 comprising a plurality of piston rod sections 32a, 32b, 32c, each of which is fixedly connected to an associated piston section 31a, 31b, 31c. The number of piston rod sections and piston sections may vary. By means of a telescopic cylinder 51, a greater stroke distance in the lifting direction H can be achieved with a compact design than with a single integrally formed piston rod 32. The telescopic cylinder 51 can be in the form of a single-acting telescopic cylinder or a double-acting telescopic cylinder (shown dashed).

FIGS. 5 to 7 show different embodiments of the fluid circuit for the lifting device 10, which can be used for a single-acting cylinder (solid and dashed lines) or a double-acting cylinder (optional dash-dotted lines) regardless of the other design of the lifting device 10.

In the embodiment shown in FIG. 5, a check valve 52 is disposed in each of the first fluid conduit 24 and the optional third fluid conduit 27 to prevent unintended flow of fluid from the elevating work chamber 23 through the first fluid conduit 24 and the third fluid conduit 27, respectively, to the fluid reservoir 26. The check valves 52 allow fluid to be supplied by the main pump 45 or the auxiliary pump 49 into the elevating work chamber 23, but prevent unintentional outflow from the elevating work chamber 23 through the respective fluid conduits 24, 27.

In the embodiment shown in FIG. 5, the flow control arrangement 47 in the second fluid conduit 25 has a switchable valve 53, for example a pilot-operated check valve, that can be switched over by means of the lowering operating element 48. The flow control arrangement 47 also has a throttle 54 connected in series therewith. In its unactuated state, the switchable valve 53 is in its blocking position and blocks a flow of fluid from the elevating work chamber 23 into the fluid reservoir 26 via the second fluid conduit 25. When the switchable valve 53 is opened by actuation of the lowering operating element 48, the flow control arrangement 47 is in its release state and allows a flow of fluid from the elevating work chamber 23 through the second fluid conduit 25 into the fluid reservoir 26. The flow is limited by the optional throttle 54 to prevent the piston rod 32 from retracting too fast, particularly when a load 20 is disposed on the support part 35. The throttle 54 can optionally be an adjustable throttle or a pressure-dependent controlled throttle. The throttle 54 can additionally or alternatively also be a component of the switchable valve 53.

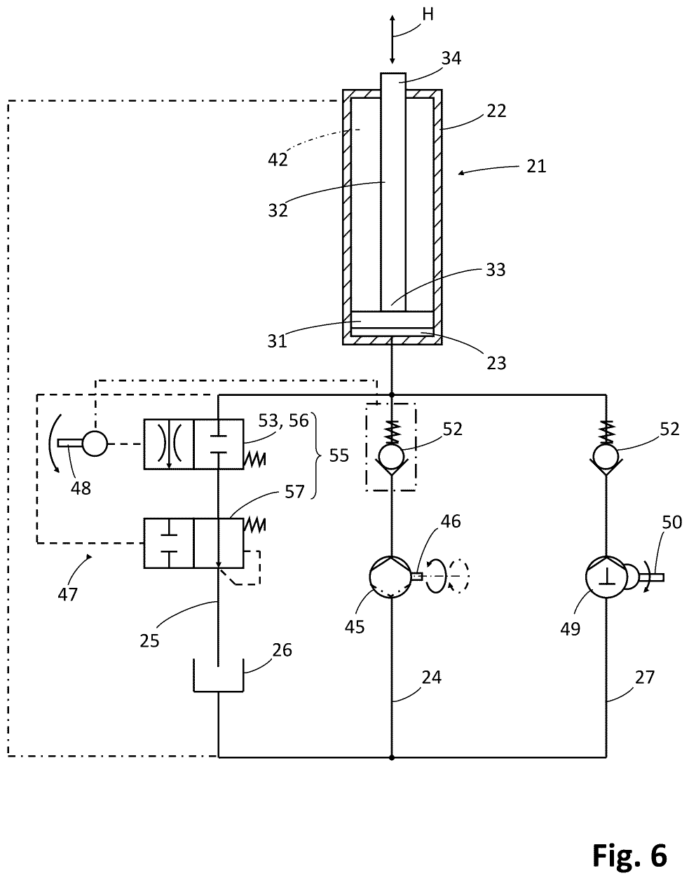

The embodiment of the fluid circuit shown in FIG. 6 differs from the embodiment shown in FIG. 5 only in the design of the flow control arrangement 47. In this embodiment, the flow control arrangement 47 has a flow-controlled valve arrangement 55. This valve arrangement 55 includes a switchable valve 53, which can be switched between two switching positions by means of the lowering operating element 48 and is here, for example, a directional control valve 56, as well as a pressure compensator or a differential pressure valve 57.

The directional control valve 56 and the differential pressure valve 57 are fluidically connected in series in the second fluid conduit 25. The pressure upstream of the directional control valve 56 and the pressure downstream of the differential pressure valve 57 are detected via the differential pressure valve 57 and set to a predetermined target differential pressure. Thus, the differential pressure applied to the directional control valve 56 is constant when fluid flows from the elevating work chamber 23 through the flow control arrangement 47 to the fluid reservoir 26 to retract the piston rod 32. The directional control valve 56 can specify the flow in the release state of the flow control arrangement 47 by means of throttling and optionally adjustable throttling. By keeping the differential pressure constant via the differential pressure valve 57, a desired flow rate can be set. As a result, the speed of the retracting movement of the piston rod 32 can be set independently of the load.

In all other respects, the embodiment example of the fluid circuit according to FIG. 6 corresponds to the embodiment example of FIG. 5, so that reference can be made to the above description.

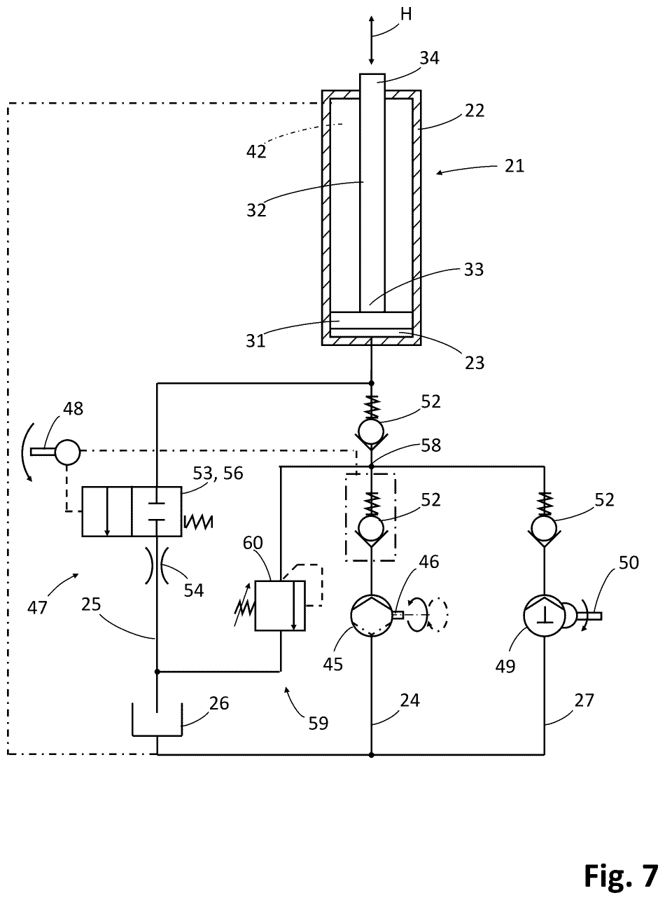

FIG. 7 illustrates another embodiment of the fluid circuit for the lifting device 10. Between the elevating work chamber 23 and a connection point 58, the fluid circuit has another check valve 52 which prevents flow from the elevating work chamber 23 in the direction of the connection point 58. As before, the second fluid conduit 25 is directly fluidly connected to the elevating work chamber 23.

The pressure provided by the main pump 45 is applied at the connection point 58. The pressure applied by the optional auxiliary pump 49 is also present at this connection point. The connection point 58 is connected to the fluid reservoir 26 via an overpressure branch 59. A preferably adjustable pressure relief valve 60 is arranged in the pressure relief branch 59. The pressure relief valve 60 opens at a set maximum pressure value and thus limits the pressure provided by the main pump 45 and/or the auxiliary pump 49 at the connection point 58 to a predetermined and preferably adjustable maximum pressure.

This embodiment with an additional check valve 52 and the overpressure branch 59 can be used in all embodiments of the fluid circuit.

The modified embodiment of the flow control arrangement 47, as illustrated in FIG. 7, can also be used in any of the embodiments of the fluid circuit. Similar to the embodiment shown in FIG. 6, the flow control arrangement 47 has a switchable valve 53, which, here, is a directional control valve 56, and has a throttle 54 in series with it. In contrast to the embodiment according to FIG. 6, the pressure compensator or differential pressure valve 57 is omitted. The throttle 54 is arranged separately from the directional control valve 56 in the second fluid conduit 25. Alternatively, the throttle 54 could also be integrated in the directional control valve 56, similar to the embodiment according to FIG. 6.

The fluid circuits shown in FIGS. 5 to 7 for the single-acting cylinder 21 can be configured for a double-acting cylinder, as shown schematically in dash-dotted form. For example, the check valve 52 arranged fluidically in series with the main pump 45 in the first fluid conduit 24 can be designed as a pilot-operated check valve that can be released or opened by operating the lowering operating element 48. Then, by means of the main pump 45, fluid can also be conveyed through the first fluid conduit 24 from the elevating work chamber 23 into the fluid reservoir 26 formed by the lowering work chamber 42, in particular to support a retracting movement of the piston rod 32, for example, in the load-free state without load 20. In this case, the main pump 45 can be rotatably driven in both directions of rotation in order to reverse the supply direction for extending and retracting the piston rod 32.

Another option usable in all embodiments of the lifting device 10 is shown in highly schematized form in FIGS. 3 and 4. The lifting device 10 may additionally comprise a locking means 65 that can be switched between a locking state and a release state. In the locking state, the locking means 65 blocks rotation of the support part 35 and/or the piston rod 32 about a longitudinal axis of the piston rod 32 relative to the cylinder housing 22 and/or the fluid container 39 and/or any other component of the lifting device 10 that is non-rotatably connected to the mobile frame 12 about the longitudinal axis of the piston rod 32. The locking state of the locking means 65 may be established automatically or manually when the piston rod 32 is in its fully retracted position or, at least starting from the fully retracted position, is only far enough away that a minimum extension distance in lifting direction H has not yet been covered.

For example, the locking means 65 may include a locking body disposed at the outer end 34 and/or on the support part 35 and, in the locking state, is present in an associated locking recess on the cylinder housing 22 and/or on the fluid container 39 and/or any other part that is non-rotatably connected to the mobile frame 12. In this locking state, the support part 35 (e.g., table, support plate, support frame, etc.) can be grasped by an operator and, via the support part 35, the lifting device 10 can be moved along the ground and can thereby also be rotated. In the locking state, only the support part 35 is prevented from rotating about the longitudinal axis of the piston rod 32 and the position of the mobile frame 12 relative to the ground is changed little or not at all in the process.

In the release state of the locking means 65, such rotation of the support part 35 relative to the cylinder housing 22 or the fluid container 39 or the mobile frame 12 is permitted. For example, the locking body is out of engagement with the associated locking recess. For example, the release state may be automatically achieved when the piston rod 32 has been extended from its fully retracted position to such an extent that the locking body no longer engages the locking recess.

The embodiments of the lifting device 10 described so far can be used as follows:

It is assumed that a load 20 is to be lifted by means of the lifting device 10. To load the support part 35 with the load 20, the piston rod 32 is preferably first brought into its fully retracted position. The support part 35 for receiving the load 20 is then in a low position and can be loaded very easily.

After loading, the lifting device 10 with the load 20 can be moved to the desired position by driving or rolling the mobile lifting device 10 over the ground by means of the mobile frame 12. If a locking means 65 is present, it is preferably in the locking state so that the mobile unit can be moved and rotated, for example, via the support part 35. If a locking means 65 is not present, a handle 66 is preferably present, which is non-rotatably connected in the circumferential direction about the longitudinal axis of the piston rod to some component of the lifting device 10, for example the cylinder housing 22 and/or the fluid container 39, which in turn is non-rotatably connected to the mobile frame 12 (FIGS. 1 and 2).

After the lifting device 10 has been positioned at the desired location, one or more of the castors 13 are preferably secured against rolling movement, for example by means of the brake 15.

Subsequently, for a fast stroke of the load 20 in the lifting direction H, the piston rod 32 can be driven by driving the main pump 45 by means of a hand tool (drill, cordless screwdriver). For this purpose, the main pump 45 supplies fluid into the elevating work chamber 23. This fast stroke allows the load 20 to be arranged at least at the approximately desired height within a short period of time. Here, extension speeds of the piston rod 32 of, for example, at least 10 cm/s or at least 15 cm/s or more can be achieved.

For fine adjustment of the position of the load 20 in the lifting direction H, the auxiliary pump 49 actuated by muscle power is optionally provided. With each stroke of the pump operating element 50, which is designed as a foot pedal, so little fluid is supplied into the elevating work chamber 23 that the load 20 is lifted only a few millimeters, for example a maximum of 10 mm with each operating movement or pumping movement via the pump operating element 50. In this way, the load 20 can be positioned very precisely in the lifting direction H at the desired height. Depending on the type of application and the load 20, it can be transported further and/or mounted and/or used in other ways at the raised height.

After further transport and/or assembly of the load 20, the support part 35 can be lowered again by retracting the piston rod 32. For this purpose, the lowering operating element 48 is actuated in the embodiment example, so that a flow of fluid from the elevating work chamber 23 into the fluid reservoir 26 is made possible.

Following this, the mobile lifting device 10 can be moved along the ground again to pick up another load 20. The process is then carried out again as described.

The lifting device 10 is also suitable in principle for applications in which a load 20 is picked up at a certain height with the piston rod 32 partially or fully extended and then lowered and transported away by means of the lifting device 10.

The present disclosure relates to a mobile lifting device 10, which preferably has a mobile frame 12 with a plurality of castors 13. The lifting device 10 has a closed fluid circuit, in particular a hydraulic circuit. It has a cylinder 21 with an elevating work chamber 23. The elevating work chamber 23 is fluidically connected to a fluid reservoir 26 via a first fluid conduit 24 and a second fluid conduit 25. In the first fluid conduit 24, a main pump 45 is arranged which can be driven by means of a rotatably drivable hand tool to supply fluid from the fluid reservoir 26 into the elevating work chamber 23, thereby extending a piston rod 32 of the fluid cylinder 21, for example, to lift a load 20. In the second fluid conduit 25, a flow control arrangement 47 is arranged which can be switched between a blocking state and a release state by means of a lowering operating element 48. When the piston rod 32 is extended, the flow control arrangement 47 is in the blocking state. To retract the piston rod 32, it is switched to the release state, allowing fluid to flow out of the elevating work chamber 23 through the second fluid conduit 25.

### LIST OF REFERENCE SIGNS

10 lifting device
11 mobile unit
12 mobile frame
13 castor
14 arm
15 brake
20 load
21 fluid cylinder
22 cylinder housing
23 elevating work chamber
24 first fluid conduit
25 second fluid conduit
26 fluid reservoir
27 third fluid conduit
31 piston
31a piston section of the telescopic cylinder
31b piston section of the telescopic cylinder
31c piston section of the telescopic cylinder
32 piston rod
32a piston rod section of the telescopic cylinder
32b piston rod section of the telescopic cylinder
32c piston rod section of the telescopic cylinder
33 inner end
34 outer end
35 support part
39 fluid container
40 intermediate space
41 fluid port
42 lowering work chamber
42a lowering work chamber section of the telescopic cylinder
42b lowering work chamber section of the telescopic cylinder
42c lowering work chamber section of the telescopic cylinder
45 main pump
46 tool interface
47 flow control arrangement
48 lowering operating element
49 auxiliary pump
50 pump operating element
51 telescopic cylinder
52 check valve
53 switchable valve
54 throttle
55 valve arrangement
56 directional control valve
57 differential pressure valve
58 connection point
59 overpressure branch
60 pressure relief valve
65 locking means
66 handle
H lifting direction
S pivot axis

1. A lifting device comprising:
a fluid cylinder comprising a cylinder housing, an elevating work chamber in the cylinder housing, a piston and a piston rod, which is fixed with an inner end to the piston and which projects with an outer end from the cylinder housing and has there a support part for supporting a load, wherein the piston adjoins the elevating work chamber and wherein the piston and the piston rod are mounted movably in a lifting direction,
a fluid reservoir,
a first fluid conduit and a second fluid conduit, each fluidically connecting the fluid reservoir and the elevating work chamber,
a rotatably drivable main pump in the first fluid conduit, which is configured to supply fluid from the fluid reservoir via the first fluid conduit into the elevating work chamber in a driven state,
a tool interface drivingly connected to the main pump and configured to be connected to a rotatably drivable hand tool to drive the main pump,
a flow control arrangement in the second fluid conduit, which in a blocking state blocks fluid flow from the elevating work chamber via the second fluid conduit into the fluid reservoir and in a release state allows fluid flow from the elevating work chamber via the second fluid conduit into the fluid reservoir, and
a lowering operating element connected to the flow control arrangement and configured to switch the flow control arrangement between the blocking state and the release state.

2. The lifting device of claim 1, formed as a mobile unit such that it can be moved and positioned at a desired location on a ground by a single person.

3. The lifting device according to claim 2, further comprising a mobile frame having a plurality of castors, such that the lifting device is configured as a rollable unit.

4. The lifting device of claim 3, further comprising locking means for locking relative rotation of the support part about a longitudinal axis of the piston rod relative to the mobile frame in a locking state and for allowing relative rotation of the support part about the longitudinal axis of the piston rod relative to the mobile frame in a release state.

5. The lifting device according to claim 4, wherein the locking means automatically assumes the locking state or can be brought into the locking state when the piston rod is retracted or fully retracted.

6. The lifting device according to claim 4, wherein the locking means automatically assumes the release state or can be brought into the release state when the piston rod is a minimum distance away from its fully retracted position.

7. The lifting device of according to claim 1, further comprising a fluid reservoir surrounding the cylinder housing, wherein the fluid reservoir is an intermediate space between the fluid reservoir and the cylinder housing.

8. The lifting device according to claim 1, wherein the fluid cylinder is a single-acting cylinder.

9. The lifting device according to claim 1, wherein the fluid cylinder is a double-acting cylinder, wherein the piston is arranged between a lowering work chamber and the elevating work chamber, and wherein the fluid reservoir is completely or partially the lowering work chamber.

10. The lifting device of claim 9, wherein the main pump is configured to supply fluid from the lowering work chamber via the first fluid conduit into the elevating work chamber in one direction of rotation when driven and to supply fluid from the elevating work chamber via the first fluid conduit into the lowering work chamber in an opposite direction of rotation when driven.

11. The lifting device according to claim 1, further comprising a third fluid conduit fluidically connecting the fluid reservoir and the elevating work chamber, an auxiliary pump in the third fluid conduit, and a pump operating element configured for operation by means of muscle power for actuating the auxiliary pump, wherein the auxiliary pump is configured to supply fluid from the fluid reservoir via the third fluid conduit into the elevating work chamber in an actuated state.

12. The lifting device of claim 11, wherein the pump operating element is a foot pedal configured to be operated by a foot.

13. The lifting device according to claim 1, wherein the lowering operating element is a foot pedal configured to be operated by a foot.

14. The lifting device according to claim 1, wherein the flow control arrangement comprises a valve switchable between a blocking state and the release state by means of the lowering operating element.

15. The lifting device according to claim 1, wherein the flow control arrangement comprises a flow-controlled valve arrangement.

16. The lifting device according to claim 5, wherein the locking means automatically assumes the release state or can be brought into the release state when the piston rod is a minimum distance away from its fully retracted position.

17. The lifting device according to claim 16, further comprising a fluid reservoir surrounding the cylinder housing, wherein the fluid reservoir is an intermediate space between the fluid reservoir and the cylinder housing.

18. The lifting device according to claim 17, wherein the fluid cylinder is a single-acting cylinder.

19. The lifting device according to claim 18, wherein the fluid cylinder is a double-acting cylinder, wherein the piston is arranged between a lowering work chamber and the elevating work chamber, and wherein the fluid reservoir is completely or partially the lowering work chamber.

20. The lifting device of claim 19, wherein the main pump is configured to supply fluid from the lowering work chamber via the first fluid conduit into the elevating work chamber in one direction of rotation when driven and to supply fluid from the elevating work chamber via the first fluid conduit into the lowering work chamber in an opposite direction of rotation when driven.
